(19) United States
(12) Patent Application Publication
(10) Pub. No.: US 2012/0150928 A1
(43) Pub. Date: Jun. 14, 2012

(54) METHOD AND SYSTEM FOR IDENTIFYING MEDIA ASSETS

(76) Inventors: Peter Ward, Manhattan Beach, CA (US); JR Yasgur, Culver City, CA (US)

(21) Appl. No.: 12/964,292

(22) Filed: Dec. 9, 2010

(51) Int. Cl. G06F 17/30

(52) U.S. Cl. 707/825; 707/E17.143

(57) ABSTRACT

A system and method for media asset management. An original media asset for a media project is identified and a plurality of versions of the original media asset is also identified. The plurality of versions of the media asset include at least one modified version of the original media asset. Typically each of the plurality of versions of the original media asset includes a plurality of components, and the modified versions of the original media asset include at least one modified component. The component being modified is based on a corresponding component of the original media asset. Metadata for each of the plurality of components is generated that indicates whether each component is a modified component, and the metadata of the modified component indicates a type of modification made to the modified component.

### BACKGROUND

1. Field of the Invention

This invention relates generally to managing media assets. More particularly, the present invention relates to utilizing characteristics of a version of a media asset to quantify a version of the media asset.

2. Background Discussion

Typically, a media asset, such as a movie production or album, is released to the public as a particular version. Following the initial release, it may be necessary to re-release the media asset in a slightly different form, or version. This may occur at or after initial release. Multiple versions may be cut for the initial theatrical release as well. This new version of the asset may be the result of editing portions of violent content, translating the movie or album into a different language, modifying the credits and other similar changes. Typically, this new version of the asset is the result of editing content for territory (e.g., UK, Germany) and/or platform (e.g., television broadcast (TNT, HBO), digital distribution (iTunes, Hulu)). These standards and practices edits may alter picture and/or audio for content (e.g., violence, nudity, profanity), runtime, rating, etc. Content may also be edited based on talent requests and/or restrictions (e.g., Director's Home Entertainment cut, scenes only approved for distribution in particular territories). Furthermore, the media asset may be edited as a result of distribution agreements (e.g., logo placement on shared-rights titles). While editing the asset is time consuming and expensive, it is also difficult to keep track of multiple versions of the same asset to confirm that a version confirms to particular criteria. Indeed, many times there will only be relatively minor changes from the original media asset and a modified version and there is no way to track each modification of the edited version relative to the original. Some edits are tracked relative to the original, others are tracked without a reference to an “original” cut. The concept of an “original version” is one with many interpretations and definitions.

### SUMMARY

Thus, embodiments of the present invention are directed to building a set of metadata associated with an edited version. These concepts also apply to any/all versions of the asset, not only “edited versions”, of a media asset (motion picture, television show recording album) that identifies criteria that the edited version of the asset satisfy. The metadata provides a structured/normalized/standardized schema to classify the attributes and criteria of the media asset. This metadata schema is critical to the accurate and efficient identification, recall, and exploitation of media assets in an array of workflows. Furthermore, this standardized and comprehensive classification of version attributes is useful for automated content identification, retrieval, and transformation.

One embodiment of the present invention is directed to a method (the method) for generating metadata of a media project that includes accessing one or more criterion related to a predetermined result of the media project. An original media asset for the media project is identified and a plurality of versions of the original media asset is also identified. The plurality of versions of the media asset includes at least one modified version of the original media asset. (As previously mentioned, this metadata schema applies to every cut on the content. As such, it applies even if there is only one version.) Typically each of the plurality of versions of the original media asset includes a plurality of components, and the modified versions of the original media asset include at least one modified component. The component that is modified is done so based on a corresponding component of the original media asset. Metadata for each of the plurality of components is generated. The metadata indicates whether each component is a modified component, and the metadata of the modified component indicates a type of modification made to the modified component. The metadata is associated with the original media asset.

Another embodiment of the present invention is directed to the method wherein the original media asset includes a movie.

Another embodiment of the present invention is directed to the method wherein the original media asset includes a television program.

Yet another embodiment of the present invention is directed to the method wherein the original media asset includes audio data.

Yet another embodiment of the present invention is directed to the method wherein the original media asset includes software.

Yet another embodiment of the present invention is directed to the method wherein the original media asset includes wherein the plurality of components include media type, territory, picture, audio, content, and color.

Yet another embodiment of the present invention is directed to the method wherein the metadata of the modified component includes indicia describing variances between the modified component and the corresponding component of the original media asset.

Yet another embodiment of the present invention is directed to the method wherein the variances include component addition, component deletion, and component substitution.

Yet another embodiment of the present invention is directed to a method wherein the metadata is displayed.

Yet another embodiment of the present invention is directed to a non-transitory computer-readable medium storing program code that when executed by a processor generates metadata of a media project by performing steps comprising accessing one or more criterion related to a predetermined result of the media project. An original media asset for the media project is identified, and a plurality of versions of the original media asset is identified. The plurality of versions of the media asset include at least one modified version of the original media asset. Typically each of the plurality of versions of the original media asset includes a plurality of components. The modified versions of the original media asset include at least one modified component. The modified component is modified based on a corresponding component of the original media asset. Metadata for each of the plurality of components that indicates whether each component is a modified component is generated. The metadata of the modified component indicates a type of modification made to the modified component. The metadata is associated with the original media asset.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an example of a system used to implement one embodiment of the present invention;

FIG. 2 illustrates an example of a series of steps for another embodiment of the present invention;

FIG. 3 illustrates an example of component levels according to an embodiment of the present invention;

FIG. 4 illustrates an example of an asset manager according to an embodiment of the present invention;

FIG. 5 illustrates an example of a series of steps to implement an embodiment of the present invention; and

FIG. 6 shows an example of steps used to implement another embodiment of the present invention; and

FIGS. 7A-7C show data structure representations according to embodiments of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. The term “component” as used herein, while defined above, is not limited to “a computer-related entity”. For example, as used herein, the term “component” is itself an asset. Components can be picture, audio, and/or text files (e.g., subtitles, closed caption files). Again, these may be components of the full-length non-episodic or episodic program. They may also be components of made-for-digital content, short-form content (e.g., made-for-digital series, minisodes), and supporting materials (e.g., trailers, teasers, value added materials). Components can be stored on numerous media, both physical and digital. Media can include, but is not limited to: film, video tapes (of numerous varieties), audio tapes (of numerous varieties), text files (of which there are numerous file types), images (e.g., jpgs, pngs), and digital files (e.g., J2Ks, mwvs, ProRes files, audio formats), etc. Physical assets may be stored in traditional storage locations (e.g., vendors, vaults). Digital assets may be stored on studiohosted servers, 3^{rd} party-hosted servers, external hard drives, etc. Components can/may also include the technical and descriptive metadata required for internal workflows and client delivery. Examples of technical and descriptive metadata may include: title, synopsis, talent, credits, runtime, color. The metadata about the versions of these content types is currently stored, in several systems. The systems of record for most metadata are database/software systems (e.g., GPMS, GOLD). This metadata is sent to other systems and entities either via established interfaces (e.g., vendor inventory systems, the Distribution Backbone), and/or extra-system reports. The term component also includes sections, or pieces or constituent portions of music products, games, electronics, etc. By way of illustration, both an application running on a server and the server can be a component. One or more components may reside within a process and/or thread of execution and a component may be localized on one computer and/or distributed between two or more computers. Other embodiments of the present invention include the methods described above but implemented using apparatus or programmed as computer code to be executed by one or more processors operating in conjunction with one or more electronic storage media. The components also apply to full-length programs as well as supporting materials (e.g., trailers, teasers, EPKs (electronic press kits), value added materials). This also includes “movie productions” as well as non-episodic content (e.g., feature films, mini-series, movies of the week (MOWs)), episodic content (e.g., television series), and made-for-digital content (e.g., Crackle original series, minisodes), and the aforementioned supporting materials. These concepts apply to original productions (e.g., studio titles). This may also apply to additional documents, such as documents that may be classified according to these metadata structures. Such documents may include, for example, scripts, music cue sheets, etc.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media. This electronic storage media may include, for example a non-transitory electronic storage medium/media such as a register, or other electronic repository or electronic storage location for data that is capable of storing data represented in electronic form, such as bits, bytes, kilobytes, waveforms, electronic signals, digital format and other data types and forms.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices.

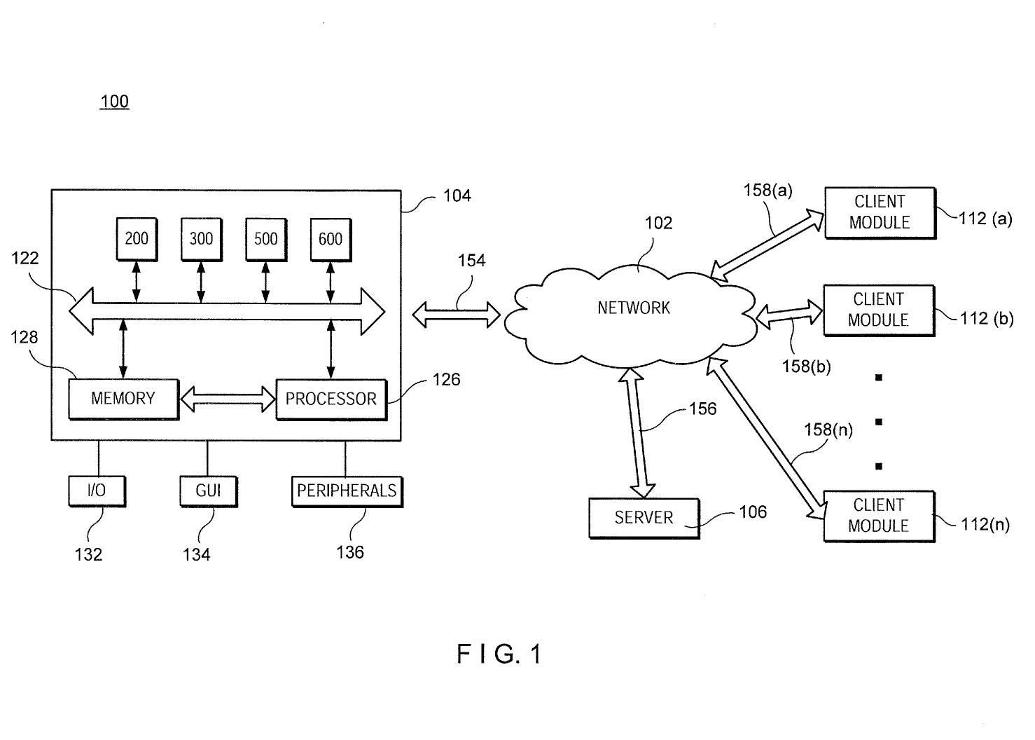

FIG. 1 illustrates an example of a system 100 that supports embodiments of the present invention. The system 100 shown in FIG. 1 includes a network 102, a processing module 104, a server 106, and one or more client modules 112(a), 112(b) . . . 112(n) (where “n” is any suitable number).

The network 102 is, for example, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The processing module 104 includes componentization module 200, component level module 300, asset management module 500, version modification module 600, memory 128 and processor 126. These elements, or modules, may be operatively coupled by a bus 122. The modules, such as a componentization module 200, asset management module 500, version modification module 600 may be for example, non-transitory electronic storage registers that operate in conjunction with a processor, such as 126, or other processors as shown and described herein to perform the function of the algorithm, or program code stored therein. Also shown in FIG. 1 are I/O (input/output) module 132, GUI 134 and peripherals 136. The modules as described as stored in memory 128 are typically program code that execute instructions stored on a non-transitory, computer-readable medium and are software components that operate with hardware components.

The server module, or facility, or unit, 106 is typically one or more processors with associated memory, such as computers, or other processing devices such as a desktop computer, laptop computer, personal digital assistant (PDA), wireless handheld device, cellular telephone, or the like. The server module 106 is capable of processing and storing data or merely capable of accessing processed and stored data from another location (i.e., both thin and fat terminals).

Client modules 112(a) . . . (n) (generally referred to as 112, herein). The client modules 112 typically include devices with processing capabilities and memory and an output displays, such as, laptop computers, desktop computers, cell phone, personal digital assistant (PDA), wireless handheld device, PLAYSTATION™, PSP™ and the like. The client modules 112 may be capable of processing and storing and displaying data themselves or merely capable of accessing processed and stored data from another location (i.e., both thin and fat terminals) and displaying the accessed or retrieved data. It is also an embodiment of the present invention that the functionality of server 106 could also be part of server 106 and/or client device, or terminal 112.

Server module 106, processor module 104 and terminals 112 are coupled to network 102 via an associated bi-directional communication medium, 156, 154 and 158, respectively, which may be for example a serial bus such as IEEE 1394, or other wire or wireless transmission medium. The processing module 104, server module 106, and the client terminal 112 may be communication appliances, or user locations, or subscriber devices.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices.

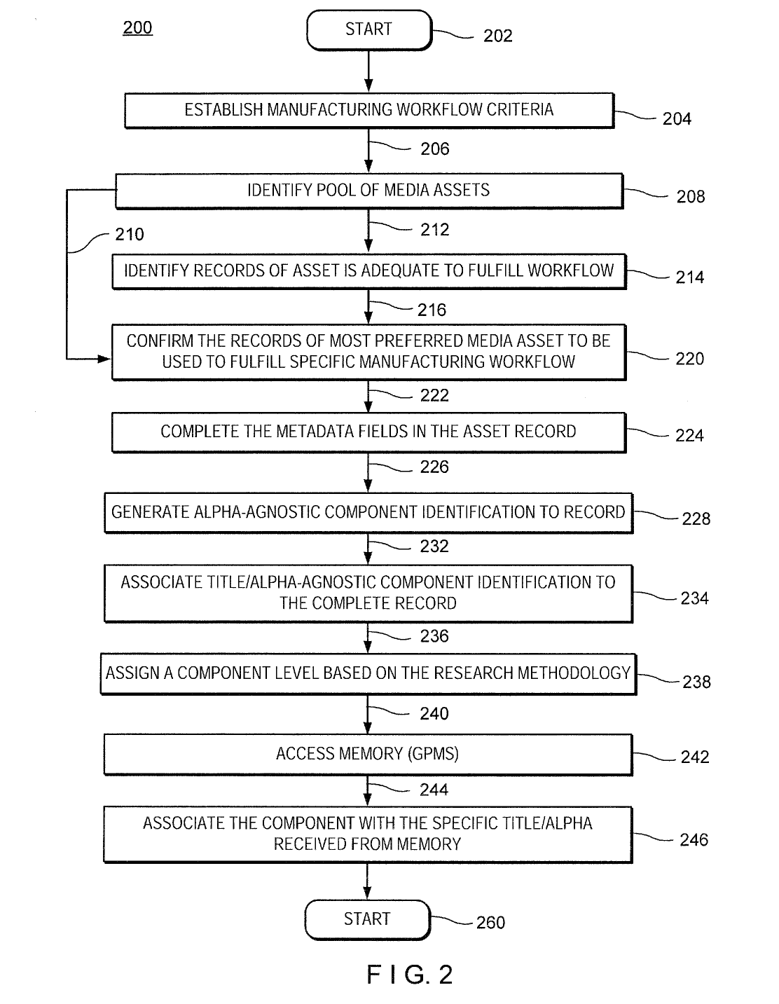

FIG. 2 illustrates an example of a series of steps 200 for an embodiment of the present invention. The series of steps 200 may be stored on a non-transitory computer readable medium or media (e.g., RAM, ROM, EEPRPOM, DRAM or other memory, electronic storage device or registry) and may be executed by a processor or plurality of processors. The steps 200, may be computer code or other program code (e.g., source code) that may be compiled into object code. The code, stored on a medium and/or accessed, is a module.

Generally, FIG. 2 shows, program code, or steps 200 of a componentization process that: identifies and confirms an asset record; completes the asset record; assigns a component identification; assigns a component level; and associates a component with a specific title or version of the asset. This computer code, or algorithm, may be stored in memory module 200 shown in FIG. 1.

Specifically, FIG. 2 shows that program code 200 begins with step 202. Step 204 shows that a manufacturing workflow criteria is established. This criteria typically includes requirements or desired characteristics of the media asset. For example, a particular language (English, Spanish, Chinese, Japanese), activities, such as a less violent action (i.e., a scene of a movie in which the characters yell at each other rather than physically fighting), background effects (telephone ring tone in the U.S. compared to a telephone ring tone in the U.K.). Line 206 shows that step 208 is reached. In step 208, a pool of media assets is identified. This pool typically includes possible versions that meet the workflow criteria. For example, this pool of assets may include versions that satisfy some, but not all the criteria.

Line 212 shows that an identification is made of a record that is adequate to fulfill the specified workflow criteria, as shown in step 214. Line 216 leads to step 220 in which the record of the most preferred media asset to be used to fulfill the specific manufacturing workflow is confirmed.

Alternatively, it is also an embodiment of the present invention that line 210 leads to step 220. In this embodiment, the confirmation (220) of the most preferred asset is performed following the identification of the media assets (208).

Line 222 shows that step 224 is reached. As shown in step 224, the metadata fields for the asset record is completed. This involves identifying characteristics of the media asset that pertain to the workflow criteria. This enhances the ability to subsequently identify the particular asset.

Line 226 shows that an alpha-agnostic component identification for the record is generated. This alpha-agnostic component permits accurate classification of the version of the media asset, as shown in step 228.

Line 232 shows that an association step 234 is reached. The association step 234 associates a title/alpha-agnostic component identification to the complete record. Line 236 shows that in step 238 a component level is assigned to the media asset based on the research methodology.

Line 240 shows that in step 242 a memory location is accessed. This memory location may be a remote storage or data base such as, for example, GPMS database. As shown by line 244, step 246 is reached. In step 246 the component is associated with the specific title/alpha received from the memory, or storage location (e.g., GPMS).

Step 260 is an end step.

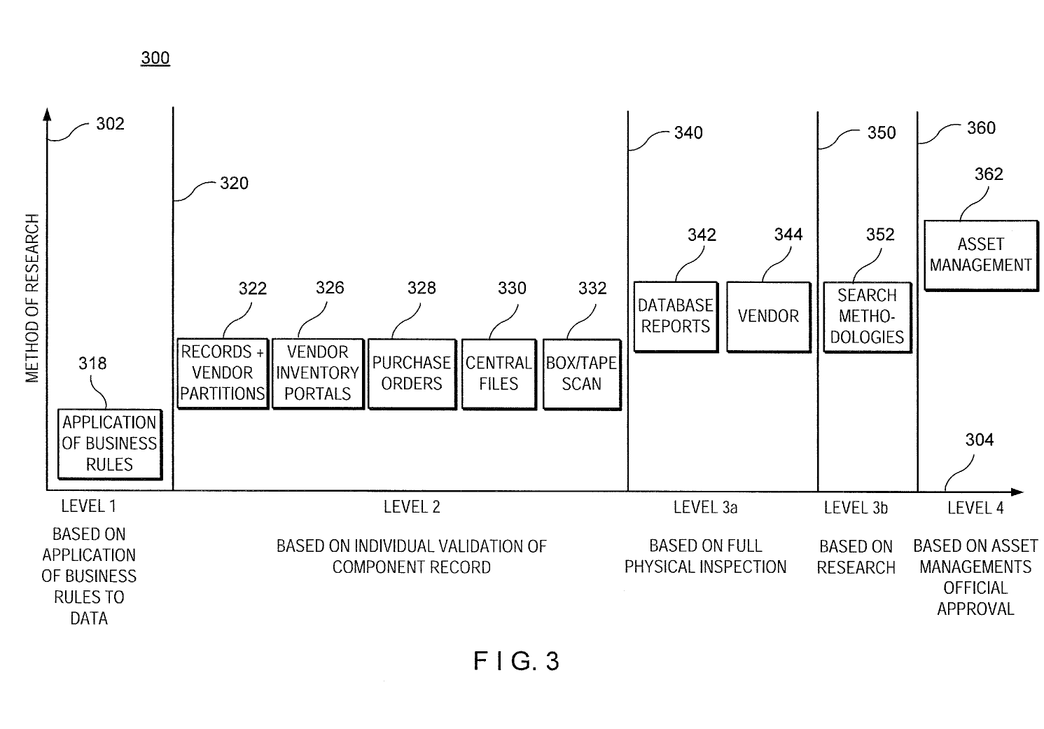

FIG. 3 illustrates an example 300 of component levels according to an embodiment of the present invention. The scheme of FIG. 3 may be stored in module 300 shown in FIG. 1. As shown in FIG. 3, Y-axis 302 shows a method of research. X-axis 304 shows various levels, specifically levels 1, 2, 3a, 3b and 4. The levels (1, 2, 3a, 3b and 4) are divided by boundaries 320, 340, 350, 360, respectively. These boundaries 320, 340, 350 and 360 can be viewed as dividing the levels. Level 1 shows that application of business rules, as shown in block 318, may be used to identify a media asset.

Level 2 shows that identification may be based on individual validation of the component record. For example, this may include records and vendor partitions (322), vendor inventory portals (326), purchase orders (328), central files (330) and box/tape scan information (332).

Level 3a shows that identification may be based on full physical inspection. This may include, for example, database reports (342) and vendor data (344). Level 3b shows that identification may be based on research. This may include search methodologies (352).

Level 4 shows that identification may be based on asset management (362). This involves the embodiments described herein, which enhances the identification and location of a media asset.

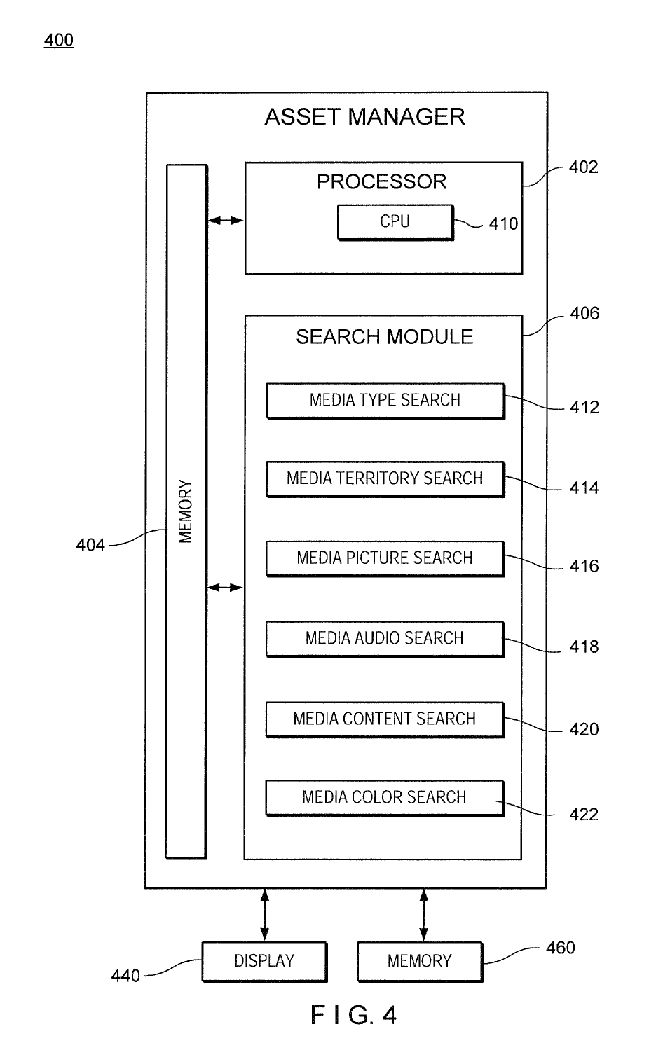

FIG. 4 illustrates an example of an asset manager module 400 according to an embodiment of the present invention. Asset management module 400 includes a processor module 402, a memory module 404 and a search module 406. The asset management module 400 may be a module, “plug-in” unit, stand-alone unit or other facility that resides on another module or device. For example, security service module may be a component of, or executed by: portable device(s) 112; server 106; and/or processing module 104, as described herein. Also components of the to asset manager module 400 are display module 440 and remote memory 460.

Processor module 402 is coupled to the search module 406 via an associated communication link to enable processor module 402 and memory 404 to coordinate processing operations of the modules shown in FIG. 4. The processor module 402 includes a CPU 410, which is typically a processor that includes an arithmetic logic unit (ALU), which performs arithmetic and logical operations, and a control unit (CU), which extracts instructions from memory and decodes and executes them, utilizing the ALU when necessary. An I/O interface may be used to operatively couple the components of processor module 402.

Memory module 404 stores programs, which include, for example, a web browser, algorithms, as well as typical operating system programs (not shown), input/output (I/O) programs (not shown), BIOS programs (not shown) and other programs that facilitate operation of asset manager module 400. The web browser (not shown) is for example an Internet browser program such as Internet Explorer™. Memory module 404 may be, for example, an electronic storage medium, such as an electronic storage repository that can store data used by asset management module 400. The memory module 404 may include, for example, RAM, ROM, EEPROM or other memory media, such as an optical disk, optical tape, CD, or a floppy disk, a hard disk, or a removable cartridge, on which digital information is stored in the form of bits. The memory module 404 may also be remote memory coupled to processing module 402 via wired or wireless bi-directional communication medium.

Search module 406 includes all the asset management functionality of various levels (see FIG. 3). For example, search module 406 includes media search type module 412, media territory search module 414, media picture search 416, media audio search 418, media content search 420 and media color search 422.

Media type search module 412 is used to search for a conforming media asset based on a type identification. This type identification may include audio, video, television, news reel, text, image or other content or storage information.

Media territory search module 414 is used to search an asset based on territory, such as a country, geographic region or other virtual or actual location.

Media picture search module 416 is used to search for an asset based on picture data associated with the asset. This picture data may include image data, audio data, scene data, starting point data, ending point data, content-related data and other information associated with a media asset.

Media audio search module 418 is used to search assets based on audio content. This may include the soundtrack or individual audio components of the media asset.

Media content search module 420 is used to search for a media asset based on the content of the asset and media color search module 422 is used to search for a media asset based on color of the asset. This may be used to distinguish between a “black and white” version of a movie or television show and a “color” version of the movie or television show.

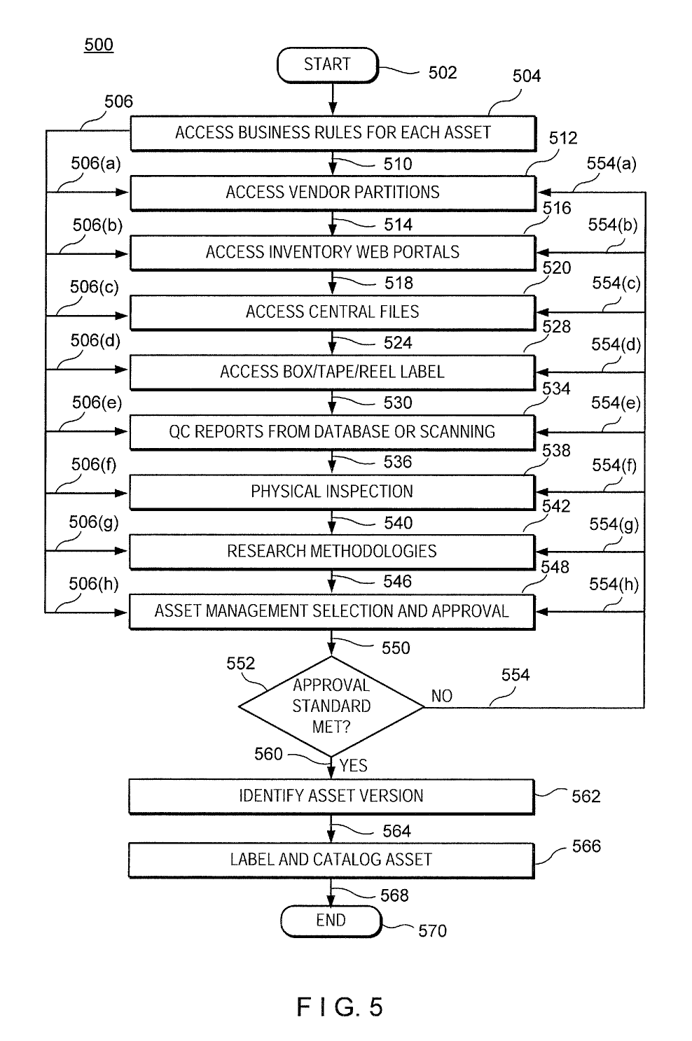

FIG. 5 illustrates an example of a series of steps 500 to implement an embodiment of the present invention. The steps 500 show a process, which is for example, a series of steps, or program code, or algorithm stored on an electronic memory or computer-readable medium. For example, the steps of FIG. 5 may be stored on a computer-readable medium, such as ROM, RAM, EEPROM, CD, DVD, or other non-volatile memory or non-transitory computer-readable medium. The process may also be a module that includes an electronic memory, with program code stored thereon to perform the functionality. This memory is a structural article. The computer program code, as an alternate form of flowchart 500 may be stored in any memory as described herein and, for example, in server 106 or processing module 104. As shown in FIG. 5, the series of steps may be represented as a flowchart 500. The process 500 begins with start step 502.

Step 504 shows that business rules for each asset are accessed. Line 506 shows that other steps may be reached. Alternatively, line 510 shows that in step 512 vendor partitions may be accessed. Step 512 may also be reached via step 506(a).

Line 514 shows that inventory web portals may be accessed, as shown in step 516. This step of accessing vendor web portals may also be reached via line 506(b).

Line 518 shows that central files may be accessed, as shown in step 520. This step of accessing central files may also be reached via line 506(c).

Line 524 shows that box/tape/reel label may be accessed, as shown in step 528. This step of accessing box/tape/reel label may also be reached via line 506(d).

Line 530 shows that QC reports may be acquired from database or by scanning, as shown in step 534. This step of acquiring QC reports may be also reached via line 506(e).

Line 536 shows that physical inspection may be acquired, as shown in step 538. This step of acquiring physical inspection may be also reached via line 506(f).

Line 540 shows that research methodologies may be acquired, as shown in step 542. This step of acquiring research methodologies may be also reached via line 506(g).

Line 546 shows that asset management selection and approval may be acquired, as shown in step 548. This step of acquiring asset management selection and approval may be also reached via line 506(h).

Line 550 shows that it is determined whether approval standard is met, as shown in step 552. If it is determined that the approval standard is not met, “no” line 554 leads back to steps 512-548 via lines 554(a)-(h), respectively, based on the component level that does not meet the approval standard. For example, if the vendor partitions accessed in step 512 do not meet the approval standard, line 554(a) leads back to step 512, and if the inventory web portals accessed in step 516 does not meet the approval standard, line 554(b) leads back to step 516, and so on.

Otherwise, in step 552 if it is determined that the approval standard is met, “yes” line 560 leads to step 562. In step 562, asset version is identified.

Line 564 shows that the identified asset is labeled and cataloged, as shown in step 566.

Line 568 leads to an end step 570.

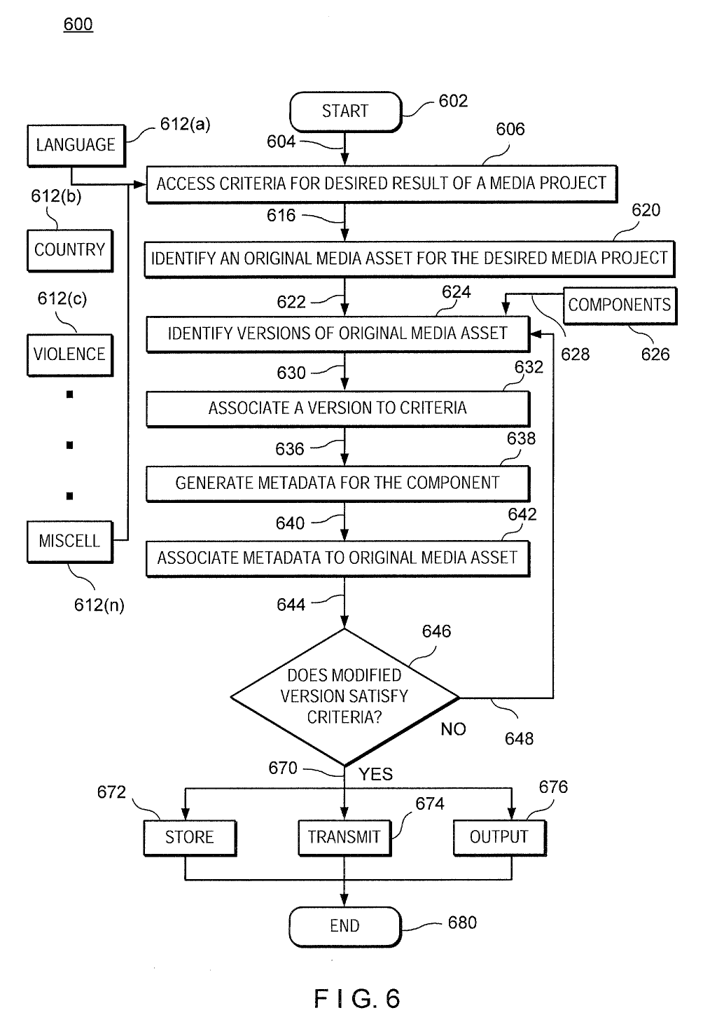

FIG. 6 illustrates an example of steps used to implement another embodiment of the present invention. The steps 600 show a process, which is for example, a series of steps, or program code, or algorithm stored on an electronic memory or computer-readable medium. For example, the steps of FIG. 6 may be stored on a computer-readable medium, such as ROM, RAM, EEPROM, CD, DVD, or other non-volatile memory or non-transitory computer-readable medium. The process may also be a module that includes an electronic memory, with program code stored thereon to perform the functionality. This memory is a structural article. The computer program code, as an alternate form of flowchart 600 may be stored in any memory as described herein and, for example, in server 106 or processing module 104. As shown in FIG. 6, the series of steps may be represented as a flowchart 600. The process 600 begins with start step 602.

Line 604 shows that a step of accessing criteria for a desired result of a media project is reached, as shown in step 606. The criteria include requirements or desired characteristics of the media asset 612(a)-612(n). For example, language requirement 612(a) indicates that the desired media project is in a particular language, such as English, Spanish, Chinese or Japanese; country requirement 612(b) indicates that the desired media project is made for a particular country, such as U.K., Spain, China or Japan; violence requirement 612(c) indicates violent actions in the desired media project, and miscellaneous requirement 612(n) indicates other requirement for the desired media project.

Line 616 shows that an original media asset for the desired media asset is identified, as shown in step 620.

Line 622 shows that various versions of the media asset are identified, as shown in step 624.

Line 630 shows that a version is associated to the criteria, as shown in step 632.

Line 636 shows that metadata for the component in step 626 is generated, as shown in step 638.

Line 640 shows that the metadata is associated to the original media asset, as shown in step 642.

Line 644 shows that it is determined whether the modified version satisfies the criteria, as shown in step 646. If it is determined that the modified version does not satisfy the criteria, “no” line 648 leads back to step 624. Also, components (626) may be used to identify the versions of the asset, as shown by line 628 leading from step 626 to step 624.

Otherwise, in step 646 if it is determined that the modified version satisfies the criteria, “yes” line 670 may lead to step 672 to store the modified version in a memory location, and/or to step 674 to transmit the modified version electronically to other terminal, and/or to step 676 to output the modified version, such as by printer.

Step 680 is an end step.

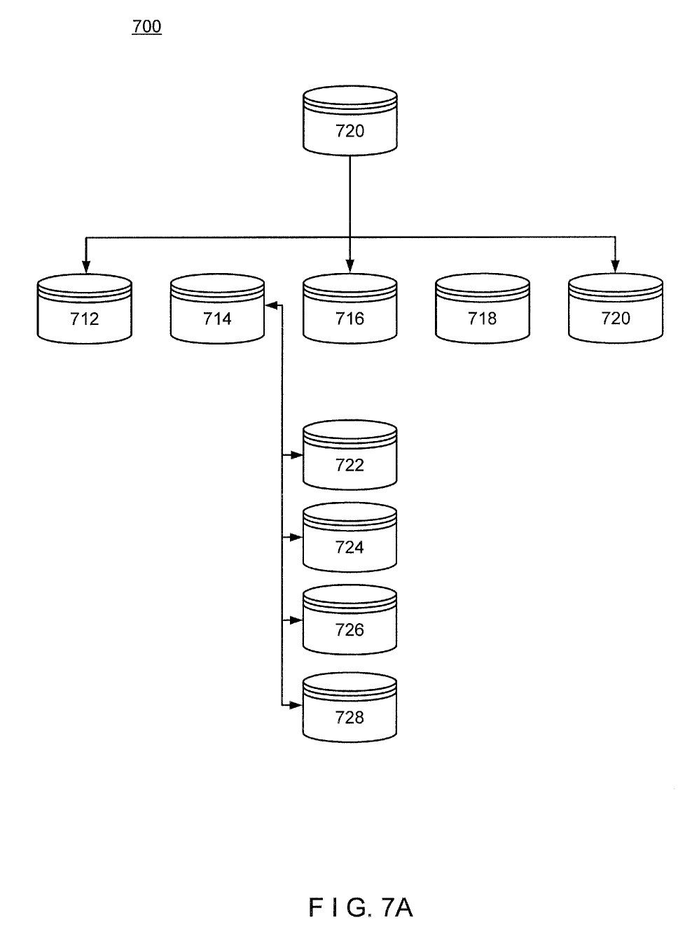

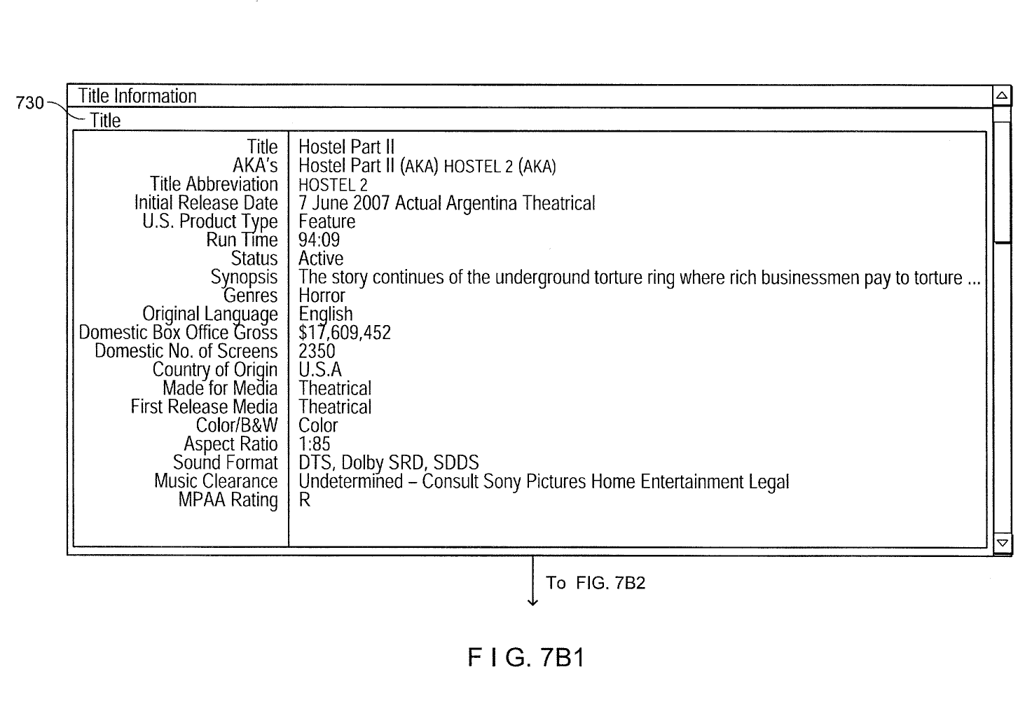

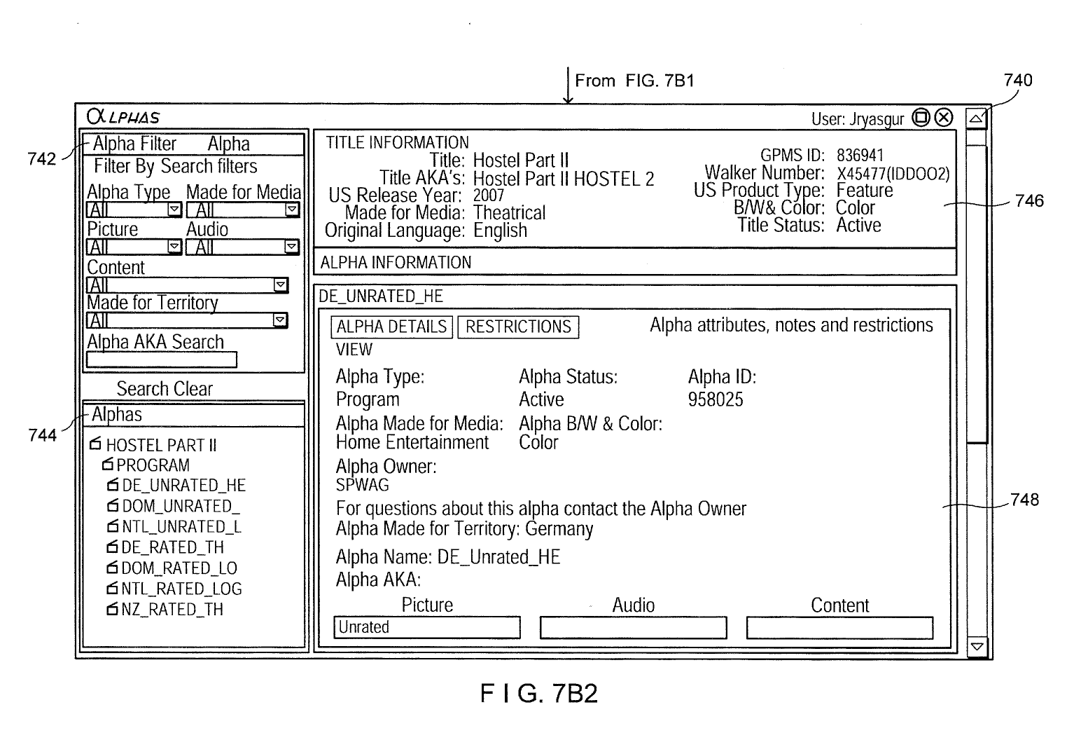

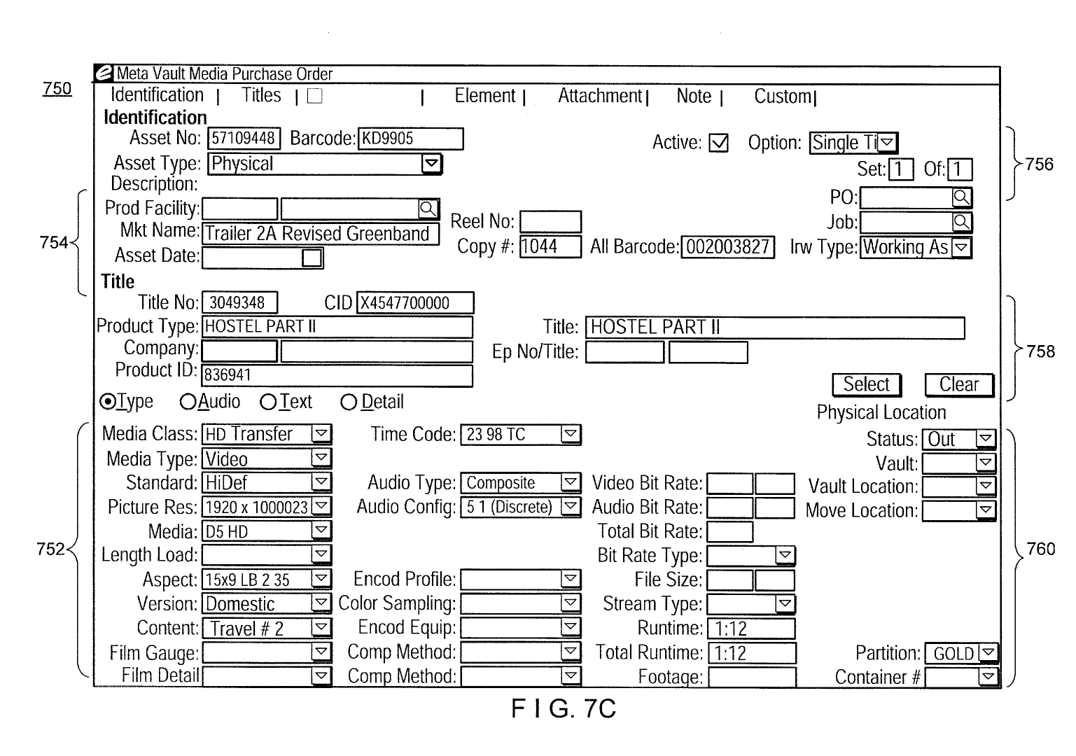

FIGS. 7A-7C show data structure representations according to embodiments of the present invention. These data structures may be stored, saved to memory, accessed from memory and/or transmitted or any combination of those functions. Specifically, FIG. 7A shows that various memory modules may be used to store identification information and/or media assets and/or other data. For example, module 702 is a database or memory location that can store a title master system that contains distribution rights (which may be maintained by another party of entity), music clearance rights, title-level marketing metadata (e.g., synopsis, cast, awards), etc.

Information, such as “Alphas” may be determined, entered, and updated by Alpha Creators and Alpha Owners in the module 702.

Module 702 is a database that is a global product master system that categorizes and manages media asset titles, distribution rights, music clearance rights and title-level marketing metadata. As shown in FIG. 7A, module 702 interfaces for Alphas; however, module 702 may be interfaced with a plurality of systems (e.g., 70+ systems, including sales databases and avails systems and other databases).

Module 712 is a database that is a distribution backbone. This module 712 includes a digital asset management (DAM) system and digital distribution system. “Alphas” are one construct within the module 712. Module 712 will store its own components that may be similar, but necessarily identical, to other components or other modules shown in FIG. 7A.

Module 714 is a database that is an order library database that may be used as a purchase order, asset management, and shipping system. This module 714 may contains over 4 million asset records for film, video, audio, digital files, etc. Media asset records (MARs) can also be associated to “Alphas” to facilitate and expedite fulfillment, ent, as part of metadata transformation.

Module 716 is a database that manages all disc (e.g., DVD and Blu-ray) profiles, critical path dates, street dates, etc. This management schedules disc projects using “Alphas”.

Module 718 is a database that functions as a servicing module for a studio that has media assets. This module is also useful as an ordering system. As an ordering system, the criteria of the asset should confirm with the studio database which “Alpha” is being requested when orders are submitted. Purchase orders for the appropriate media services are then submitted, for example by using module 714 (order library database).

Module 720 is a database that is used to identify and prioritize additional systems to receive “Alphas”. This database module 720 may be used to market and leverage “Alphas” so that the metadata may be widely used and integrated, to any system, regardless of platform.

Module 722 is a database that enables interfacing between other modules, such as distribution backbone database 712 and order library database 714. This interface may be used for inventory visibility and reporting, as well as financial approvals.

Module 724 is a database that serves as a uni-directional interface that provides the studio and other vendors and/or purchasers with read-only visibility to particular media assets in inventory.

Module 726 is a database that serves as a uni-directional interface that provides read-only visibility to a media assets in a second inventory. That is the visibility granted by module 726 is a different inventory than may be accessed using module 724.

Module 728 is a database that also serves as a uni-directional interface that provides read-only visibility to a media assets in a second inventory. That is the visibility granted by module 728 is a different inventory than may be accessed using module 724 or module 726.

FIG. 7B shows a data structure representation that may be displayed on a screen, output displayed as a pixel representation or other data out representation. As shown in FIG. 7B, area 730 shows a media data record that is identified by title. Other media asset identification data is also shown. This other data may include, for example, AKA (also known as), initial release date, U.S. product type, run time, status, synopsis, genres, original language, domestic box office gross, domestic number of scenes, country of origin, made for media, first release media, color or black and white, aspect ratio, sound format, music clearance and MPAA rating. Each category has data that identifies the media asset for the category.

As shown in portion 740, “Alphas” are identified and displayed. For example, “alpha” filter 742 filters media assets based on pre-selected criteria, these may include, as shown; in FIG. 7B, for example, alpha-type, made for media, Picture, audio, made for territory alpha AKA search. Thus the media asset may be identified/retrieved based on the desired parameter(s).

Display area 744 shows the alphas sort result. Media assets that conform to the desired criteria are displayed. Display area 746 shows title information as well as other specifics. Display area 748 is another view of a media asset according to an embodiment of the invention.

FIG. 7C shows a data structure representation 750 that may be displayed on a screen, output displayed as a pixel representation or other data out representation. As shown in FIG. 7C, display area 754 provides a display of a description of a media asset that has been identified and categorized. This includes a description using parameters such as the market name, asset date, reel number, copy number, barcode, inventory type and others.

Display area 756 shows a display area that has identification fields such as asset number asset date, an active status identifier and an option filed. These fileds, as well as others that are not shown, may be populated with data.

Display area 758 shows a display area that has title information. This includes a title number, product type, company, product identification, CID and other fields.

Display area 752 shows a display area that has type information. This includes, for example, fields for media class, media type, standard, picture resolution, media, length, aspect, version, content, time code, audio type, audio configuration, encoding profile, color sampling, encoding equipment, measure type, video bit rate, audio bit rate, bit gate type, file size, stream type, runtime, and footage.

Display area 760 shows a display of physical location data that includes, for example, status, vault, vault location and move location. It also shows a partition field and container field.

Various embodiments of the embodiments of the present invention will now be described in relation to the description and figures mentioned above. For example, the embodiments described herein relate to a system for “componentization” of media assets, such as movies, major motion picture releases, television programs, audio soundtracks, albums, video games and substantially any audio, video and/or audio/video data. The componentization process identifies media assets to build a media project thereby enhancing organization and identification of the various media assets. For example, a particular version or alpha of a media project has a collection of media assets, or components. By associating metadata with each component it is possible to track and quantify each asset to a high degree of specificity (e.g. a version that is in a particular language with certain content edited). This facilitates categorizing the media assets in a collection of media assets.

In the present invention, various versions may be represented utilizing different Edit Decision List (EDL). Each EDL contains a list of timecode data, such as time in and time out, to represent where each video clip can be obtained. For example, a modified version of a movie which includes less violent content than the original version may be obtained by creating a new EDL based on the original version of the movie.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device, such as a non-transitory computer-readable medium. The application program can be uploaded to, and executed by, a machine, such as a processor, CPU or compiler, comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method for generating metadata of a media project comprising:
accessing one or more criterion related to a predetermined result of the media project;
identifying an original media asset for the media project;
identifying a plurality of versions of the original media asset, the plurality of versions of the media asset including at least one modified version of the original media asset,
wherein each of the plurality of versions of the original media asset includes a plurality of components, and the modified versions of the original media asset includes at least one modified component which is modified based on a corresponding component of the original media asset;
generating metadata for each of the plurality of components that indicates whether each component is a modified component, and the metadata of the modified component indicates a type of modification made to the modified component; and
associating the metadata with the original media asset.

2. The method as recited in claim 1 wherein the original media asset includes a movie.

3. The method as recited in claim 1 wherein the original media asset includes a television program.

4. The method as recited in claim 1 wherein the original media asset includes audio data.

5. The method as recited in claim 1 wherein the original media asset includes software.

6. The method as recited in claim 1, wherein the plurality of components include media type, territory, picture, audio, content and color.

7. The method as recited in claim 1, wherein the metadata of the modified component includes indicia describing variances between the modified component and the corresponding component of the original media asset.

8. The method as recited in claim 7, wherein the variances include component addition, component deletion and component substitution.

9. The method as recited in claim 1, further comprising:
displaying the metadata.

10. A non-transitory computer-readable medium storing program code that when executed by a processor generates metadata of a media project by performing steps comprising:
accessing one or more criterion related to a predetermined result of the media project;
identifying an original media asset for the media project;
identifying a plurality of versions of the original media asset, the plurality of versions of the media asset including at least one modified version of the original media asset,
wherein each of the plurality of versions of the original media asset includes a plurality of components, and the modified versions of the original media asset includes at least one modified component which is modified based on a corresponding component of the original media asset;
generating metadata for each of the plurality of components that indicates whether each component is a modified component, and the metadata of the modified component indicates a type of modification made to the modified component; and
associating the metadata with the original media asset.

11. The program code as recited in claim 10 wherein the original media asset includes a movie.

12. The program code as recited in claim 10 wherein the original media asset includes a television program.

13. The program code as recited in claim 10 wherein the original media asset includes audio data.

14. The program code as recited in claim 10 wherein the original media asset includes software.

15. The program code recited in claim 10, wherein the plurality of components include media type, territory, picture, audio, content and color.

16. The program code as recited in claim 10, wherein the metadata of the modified component includes indicia describing variances between the modified component and the corresponding component of the original media asset.

17. The program code as recited in claim 16, wherein the variances include component addition, component deletion and component substitution.

18. The program code as recited in claim 10, further comprising the step of:
displaying the metadata.
